(19) United States
(12) Patent Application Publication
(10) Pub. No.: US 2009/0255064 A1
(43) Pub. Date: Oct. 15, 2009

(54) Dyeing of Polyamide Fibers

(76) Inventors: Manfred Jungen, Shanghai (CN); Udo Schmitt, Schopfheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 12/083,177

(22) PCT Filed: Sep. 20, 2006
(86) PCT No.: PCT/EP2006/066549

§ 371 Date: Apr. 3, 2008

(30) Foreign Application Priority Data
Oct. 7, 2005 (EP) 05021866.8

(51) Int. Cl. C09B 67/10

(52) U.S. Cl. 8/597

(57) ABSTRACT

The present invention relates to a process for dyeing fibre materials composed of natural or synthetic polyamides wherein an alkoxylated and quaternized fatty acid amine, preferably an oleylamine, is used as a leveling agent. The present compound leads to very uniform dyeings and is very effective in low concentrations.

This invention relates to a process for dyeing natural and synthetic polyamides or polyamide-containing materials with the aid of a leveling agent to obtain uniform dyeings.

Leveling agents or assistants are generally surface-active textile dyeing auxiliaries which have the task of thoroughly wetting the fibre/fibre blend to be dyed, of promoting penetration of the fibres and of preventing too rapid uptake of the dyes, which can lead to unlevelness (spottiness), during the dyeing operation. Suitable leveling assistants include oleylsulphonates, fatty alcohol sulphonates, fatty acid condensation products, alkyl and alkylaryl polyglycol ethers and surface-active chemicals in general.

Unlevelness is caused by:
High and varying affinity of the dye on the fibre
High and varying affinity of the fibre for the dye
Uneven distribution of the dye solution on the fabric or fibre
Temperature differences on the fabric or fibre

Insufficient levelness can be prevented by means of suitable dyeing techniques (including improving the diffusion of the solution within the fabric, pH control) and by means of leveling assistants.

Leveling assistants reduce mainly the rate of dyeing, increase the rate of dye migration within the fabric and improve the compatibility of the dyes.

Leveling agents can also have other effects which have no direct influence on the dye-fibre interactions, but nevertheless exert a positive effect on the dyeing. These include the improved solubility or the dispersion stability of the dye.

Leveling assistants can exert two or more of the abovementioned effects at the same time.

Leveling assistants can be divided into two groups, those which have an affinity for the fibre and those which have an affinity for the dye.

Leveling assistants with an affinity for dyes form an addition compound with the dye whose stability is concentration dependent and normally decreases with increasing temperature.

The dye distribution equilibrium between the dye in solution and the dye in the fibre is therefore shifted to the dye in solution. The increased dye concentration in the dye solution makes it possible for regions of the fabric which were dyed in a non-level manner to level out as a result of dye migration.

Effective leveling assistants have an affinity for the dye that is sufficient to reduce the absorption rate or to speed the migration rate. Differences in the absorption behaviour of different dyes can likewise be leveled, so that the dyes in a dye mixture can go on at a uniform rate.

Assistants with an affinity for dyes can also be used to level previously dyed materials. Assistants with an affinity for fibres go onto the fibre in competition with the dye. This competition reaction reduces the absorption rate and promotes the migration rate.

Important dye-affinity leveling assistant types for polyamides are nonionic surfactants, cationic compounds or ethoxylated compounds.

Important fibre-affinity leveling assistant types for polyamides are cationic compounds.

Leveling assistants used for polyamides are frequently ethoxylated amine compounds, partially quaternized, as disclosed for example in EP-A-135 198, EP-A-305 858 or EP-A-593 392.

Yet there still continues to be a need for even more effective leveling agents.

It has now been found that, surprisingly, quite specific quaternized and ethoxylated amine compounds based on unsaturated fatty acids are very useful as leveling agents for polyamides.

The present invention accordingly provides a process for dyeing fibre materials composed of natural or synthetic polyamides, characterized in that one or more compounds of formula (I)

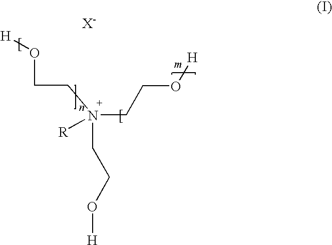

where
R is singly or doubly unsaturated alkenyl of 12 to 24 carbon atoms,
X⁻ is an anion, and
(n+m) has an average value in the range from 14 to 29,
are used as active substance of a leveling agent.

The above process is advantageous when
R is a radical derived from oleic acid, linoleic acid or linolenic acid,
X⁻ is chloride, bromide, iodide, methosulphate, sulphate, phosphate or acetate, and
(n+m) has an average value in the range from 17 to 19.

Preferably, the active substance is a compound of formula (II)

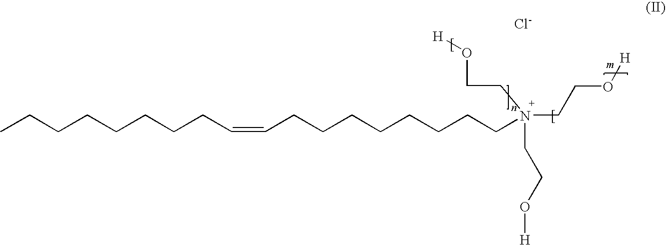

where
(n+m) has an average value in the range from 17 to 19.

Advantageously, the active substance is used as an aqueous solution wherein the concentration of active substance is in the range from 15% to 35% by weight.

It is particularly advantageous when the concentration of active substance in the aqueous solution is in the range from 25% to 35% by weight and when 0.1 % to 5% by weight of foam-suppressing substances are included as further additives.

The dyeing is usually carried out at a pH in the range from 2 to 9, preferably in the range from 3 to 8, and especially in the range from 4 to 7.

It is further advantageous when the liquor ratio is in the range from 3:1 to 50:1 in the case of a batch dyeing, preferably in the range from 5:1 to 20:1, and in the range from 5:1 to 500:1 in the case of a continuous dyeing, preferably in the range from 20:1 to 300:1.

X⁻ represents a customary inorganic or organic anion such as halides (chloride, bromide, iodide), sulphate, sulphonate, methosulphate, ethylsulphate, hydroxide, phosphate, phosphonate or acetate. Chloride is preferred.

The present active substance is known (CAS No. 747377-35-1 and 133189-76-1) and is simple to prepare by alkoxylation of the corresponding fatty amine. The alkoxylation can also be carried out with propylene oxide instead of ethylene oxide or ethylene oxide and propylene oxide, randomly or as a block, but exclusively ethoxylated amines give better results. Furthermore, the alkoxylate obtained could be completely or partially sulphonated or sulphated, although here too the non-sulphonated and non-sulphated species demonstrate better efficacy. The active substance contains in general 15 to 30 ethylene oxide (EO) units, preferably 17 to 19 EO. The active substance is particularly preferably an oleylamine with 17 to 19 EO, which was quaternized with 1 EO and contains chloride as counter-ion.

As well as the foam-suppressing substances mentioned, further additives can be used such as biocides, if desired or necessary dispersing assistants or wetting agents, for example sulphonated or sulphated alkyl, alkenyl or aryl polyglycol ethers, sulphonated or sulphated alkyl, alkenyl or aryl amine polyglycol ethers, and if desired or necessary defoamers based on silicone oil or mineral oil. It is preferable to use 2-ethylhexylisononanamide as foam-suppressing substance and a C₁₂₋₁₅-alcohol with 8 ethylene oxide and 4 propylene oxide units as wetting component with an additional foam-suppressing effect.

The examples which follow illustrate the invention. Unless otherwise stated, parts and % are by weight.

### Test Methods

Some test methods well known to one skilled in this art will now be described.

### Ross-Miles Foam Test

The volume of foam is measured after a certain amount of liquid has been poured from a certain height, instantly and also after a one minute wait.

A 1000 ml graduated cylinder 60 mm in internal diameter and 430 mm in internal height is used. The test liquid is allowed to pour out from a 2 l separating funnel through a capillary 70 mm in length and 2 mm in internal diameter from a height of 600 mm, measured from the outlet of the capillary above the floor of the cylinder.

500 ml of the solution to be tested are filled into the separating funnel and allowed to flow out into the graduated cylinder at the capillary-controlled efflux rate of about 0.17 l/min. As soon as the entire solution has flowed out, a stop watch is started and the entire volume (foam volume plus solution volume) is read off the cylinder scale. The reading is repeated after one minute.

The alkaline foam performance is tested using a surfactant concentration of 2 g/l in 2° Bé—NaOH solution in demineralized water, with 2° Bé—NaOH being equivalent to 12 g/l NaOH solid or 30 ml/l of 36° Bé NaOH. The test temperature is in the range from 20 to 25° C.

Foam Test by continuous Flow Method

| | |
|---|---|
| Material: | 1 tall graduated cylinder, peristaltic pump, rubber hose, 2 glass tubes, 1 long |
| | one reaching from 1 cm above the floor to the end of the cylinder and which |
| | is connected by a rubber hose, which leads through the pump, to a short, |
| | second glass tube situated at the level of a typical Ross Miles apparatus. |
| Concentration: | 2 g/l surfactant test solution in neutral or alkaline medium |
| Procedure: | 1.00 g of surfactant is dissolved at room temperature (always exactly the |
| | same) in exactly 500 ml of deionized water and stirred until a homogeneous |
| | solution or mixture is obtained. This mixture is carefully introduced into the |
| | 1 l graduated cylinder (previously washed out with deionized water), so that |
| | no foam is formed. A glass tube transports the solution from the floor (1 cm |
| | above) of the cylinder through a rubber hose by means of a peristaltic pump |
| | to the second glass tube, where the solution falls into the cylinder. The |
| | solution is continuously recirculated at 180 ml/min. The foam height after 1 |
| | minute, 5 minutes and 10 minutes is noted. The pump is stopped after 10 |
| | minutes. The foam height 1 minute after the pump has been switched off is |
| | noted as well. |

Leveling Effect on Polyamide with Acid Dyes: Column Test

Material

Nylsuisse knit N66 Art. 2044

### Dyeing Apparatus

Colorstar with special insert for columns

### Liquor Ratio

15:1; demineralized water

### Dyes, Buffer

Dyeing was carried out with various concentrations of mono- and disulphonated acid dyes based on azo or anthraquinone, for example Acid Blue 40, Acid Blue 72, Acid Blue 280, Acid Red 57, Acid Red 266, Acid Red 299, Acid Orange 127, Acid Orange 156 or mixtures thereof (Nylosan® E and Nylosan® N dyes from Clariant).

### Dyeing Liquors: Buffer Solution pH 5.

(Concentration series without leveling agent and with 0%, 5%, 1%, 1.5%, 2%)

### Liquor Circulation

35 ml/min, (5 l/min kg=⅓ circulation/min)

### Dyeing Procedure

The liquor is introduced into the dyeing apparatus followed, after the flow has stabilized, by the textile material. After heating with full power at room temperature to 98° C., the fabric is treated at 98° C. for 15 min, and then cooled back down to 70° C. and subsequently rinsed with cold water for 10 min.

### Assessment

The fabric columns are illustrated as follows:

| | |
|---|---|
| Sample taken: | The fabric column is divided into 4 equal parts. Sample |
| | taking from the column: bottom, after ¼, ½, ¾ |
| | and top. |
| Evaluation: | The penetration of the substrate column is evaluated. |
| | The assessment is done visually against the product to |
| | be compared. |

### Composition of Inventive Composition (Hereinafter Referred to as P1):

| Constituent | % |
|---|---|
| Active substance (quaternized oleylamine with 17 to 19 EO, | 20.0 |
| quaternized with 1 EO, chloride as counter-ion) | |
| 2-Ethylhexylisononanamide | 0.10 |
| C₁₂₋₁₅-alcohol with 8 EO and 4 PO | 0.90 |
| Demineralized water | 79.0 |

The following products were tested as well:

| | |
|---|---|
| P2: | Oleylamine with 14 EO, quaternized with 1 EO, acetate |
| | as counter-ion |
| P3: | Oleylamine with 15 EO, not quaternized |
| P4: | Tallow fatty amine 8 EO |
| P5: | Tallow fatty amine 7 EO quaternized with 1 EO, chloride |
| | as counter-ion |

Comparative Products from Prior Art:

| | |
|---|---|
| V1: | an ethoxylated behenylaminepropylamine (Sandogen ® NH from |
| | Clariant) |
| V2: | an ethoxylated and sulphonated long-chain (C₂₀-C₂₂) fatty amine |
| | mixed with a similarly long-chain quaternized fatty amine |

### Results:

where: +++++=top level; ++++=level; +++=relatively level; ++=still acceptable; +=unlevel; 0=relatively unlevel; −=very unlevel; −−−−−=totally unlevel

In the foam test, the value reported first is the value obtained after 10 min circulation and the value in brackets represents the foam volume obtained after the pump has been idle for 1 min.

| | | | Continuous foam |
|---|---|---|---|
| | | | test (2 g/l of sub- |
| | Penetration of | Penetration of | stance, neutral, |
| | column with | column with | 60° C., 10 min |
| | Nylosan N dyes | Nylosan E dyes | circulation) |
| Without | totally unlevel | totally unlevel | 0 (0) |
| assistant | (−−−−−) | (−−−−−) | |
| With 0.25% | slightly unlevel | slightly unlevel | 50 (5) |
| of P1 | (+++) | (+++) | |
| With 0.5% | moderately level | moderately level | 50 (5) |
| of P1 | (++++) | (++++) | |
| With 1.0% | level | level | 50 (5) |
| of P1 | (+++++) | (+++++) | |
| With 2.0% | level | level | 50 (5) |
| of P1 | (+++++) | (+++++) | |
| With 0.25% | not acceptable | not acceptable | 320 (280) |
| of P2 | (++) | (++) | |
| With 0.25% | unlevel | unlevel | 300 (250) |
| of P3 | (+) | (+) | |
| With 0.25% | very unlevel | very unlevel | 200 (150) |
| of P4 | (−) | (−) | |
| With 0.25% | relatively unlevel | relatively unlevel | 250 (200) |
| of P5 | (0 to +) | (0 to +) | |
| Prior art with | unlevel | unlevel | 300 (200) |
| 0.25% of V1 | (+) | (+) | |
| Prior art with | slightly unlevel | slightly unlevel | 300 (200) |
| 0.5% of V1 | (+++) | (+++) | |
| Prior art with | unlevel | unlevel | >700 (600) |
| 0.5% of V2 | (+) | (+) | |

The test results have shown that an amount as small as 0.5% of the inventive composition will ensure the penetration of the polyamide column; that is, the fabric samples are dyed level, which is not the case or cannot be achieved without assistant.

1. A process for dyeing a fiber material composed of natural or synthetic polyamide, comprising the step of contacting the fiber material with at least one compound of formula (I) 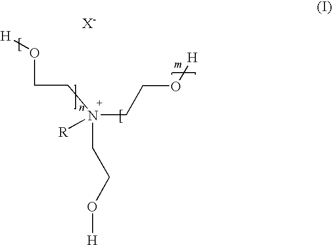
wherein
R is singly or doubly unsaturated alkenyl of 12 to 24 carbon atoms,
X⁻ is an anion, and
(n+m) has an average value in the range from 14 to 29.

2. A process according to claim 1, wherein
R is a radical derived from oleic acid, linoleic acid or linolenic acid,
X⁻ is chloride, bromide, iodide, methosulphate, sulphate, phosphate or acetate, and
(n+m) has an average value in the range from 17 to 19.

3. A process according to claim 1, wherein the
R is a radical derived from oleic acid,
X⁻ is chloride, and
(n+m) has an average value in the range from 17 to 19.

4. A process according to claim 1, wherein the compound of Formula I is in an aqueous solution in the range from 15% to 35% by weight.

5. A process according to claim 4, wherein the concentration of the compound of Formula I is in the aqueous solution is in the range from 25% to 35% by weight and wherein the aqueous solution further comprises 0.1 % to 5% by weight of at least one foam-suppressing substance.

6. A process according to claim 1, wherein the contacting step is at a pH in the range from 2 to 9.

7. A process according to claim 1, wherein the liquor ratio of the contacting step is in the range from 3:1 to 50:1 in the case of a batch dyeing and in the range from 5:1 to 500:1 in the case of a continuous dyeing.

8. A process according to claim 1, wherein the liquor ratio of the contacting step is in the range from 5:1 to 20:1 in the case of a batch dyeing and in the range from 20:1 to 300:1 in the case of a continuous dyeing.

9. A natural or synthetic polyamide fiber material dyed by the process according to claim 1.
